(19) United States
(12) Patent Application Publication
(10) Pub. No.: US 2016/0089873 A1
(43) Pub. Date: Mar. 31, 2016

(54) METHOD FOR FORMING A HYDRAULIC TRANSFER FILM

(71) Applicant: Daigin Chemical Co., Ltd., Taipei (TW)

(72) Inventors: Han-Cheng Wu-Lu, Taipei (TW); Chao-Chein Huang, Taoyuan City (TW)

(21) Appl. No.: 14/863,472

(22) Filed: Sep. 24, 2015

(30) Foreign Application Priority Data
Sep. 26, 2014 (TW) 103133596

(51) Int. Cl. B41F 9/06; B44C 1/175

(52) U.S. Cl. CPC B41F 9/063; B44C 1/1756

(57) ABSTRACT

A method for forming a hydraulic transfer film includes: (a) forming a pattern layer on a water-soluble substrate by gravure printing using a laser-engraved cylinder, the pattern layer including at least two oil-soluble regions that are separated from each other by a spacing, the water-soluble substrate being exposed from the spacing; (b) forming an oil-soluble base layer on the water-soluble substrate to cover the pattern layer and to fill the spacing between the oil-soluble regions;

and (c) forming a curable activating layer on the oil-soluble base layer to obtain the hydraulic transfer film, the activating layer including a curable activating agent that partially permeates into and is intermingled with the oil-soluble base layer and the pattern layer.

### CROSS-REFERENCE TO RELATED APPLICATIONS

This application claims priority of Taiwanese Patent Application No. 103133596, filed on Sep. 26, 2014.

### FIELD

The disclosure relates to a method for forming a hydraulic transfer film.

### BACKGROUND

A conventional hydraulic transfer film is formed by first forming a pattern layer on a water-soluble substrate by gravure printing using an electronic-engraved cylinder, and then forming an activating layer on the pattern layer and the water-soluble substrate.

However, the pattern layer formed by using the electronic-engraved cylinder only has a thickness ranging from 1 μm to 2 μm, which is insufficient to form a desirable three-dimensional pattern. Furthermore, it is desirable to improve abrasion resistance of the pattern layer of the conventional hydraulic transfer film.

### SUMMARY

Therefore, an object of the disclosure is to provide a method for forming a hydraulic transfer film that may alleviate at least one of the aforesaid drawbacks associated with the prior art.

According to an aspect of the present disclosure, a method for forming a hydraulic transfer film includes:

(a) forming a pattern layer on a water-soluble substrate by gravure printing using a laser-engraved cylinder, the pattern layer including at least two oil-soluble regions that are separated from each other by a spacing, the water-soluble substrate being exposed from the spacing;

(b) forming an oil-soluble base layer on the water-soluble substrate to cover the pattern layer and to fill the spacing between the at least two oil-soluble regions; and

(c) forming a curable activating layer on the oil-soluble base layer to obtain the hydraulic transfer film, the activating layer including a curable activating agent that partially permeates into and is intermingled with the oil-soluble base layer and the pattern layer.

### BRIEF DESCRIPTION OF THE DRAWINGS

Other features and advantages of the present disclosure will become apparent in the following detailed description of the embodiment with reference to the accompanying drawings, of which:

FIGS. 1 to 4 show consecutive steps of forming a hydraulic transfer film of an exemplary embodiment according to the present disclosure; and

FIGS. 5 to 7 show consecutive steps of forming a patterned article using the exemplary embodiment.

### DETAILED DESCRIPTION

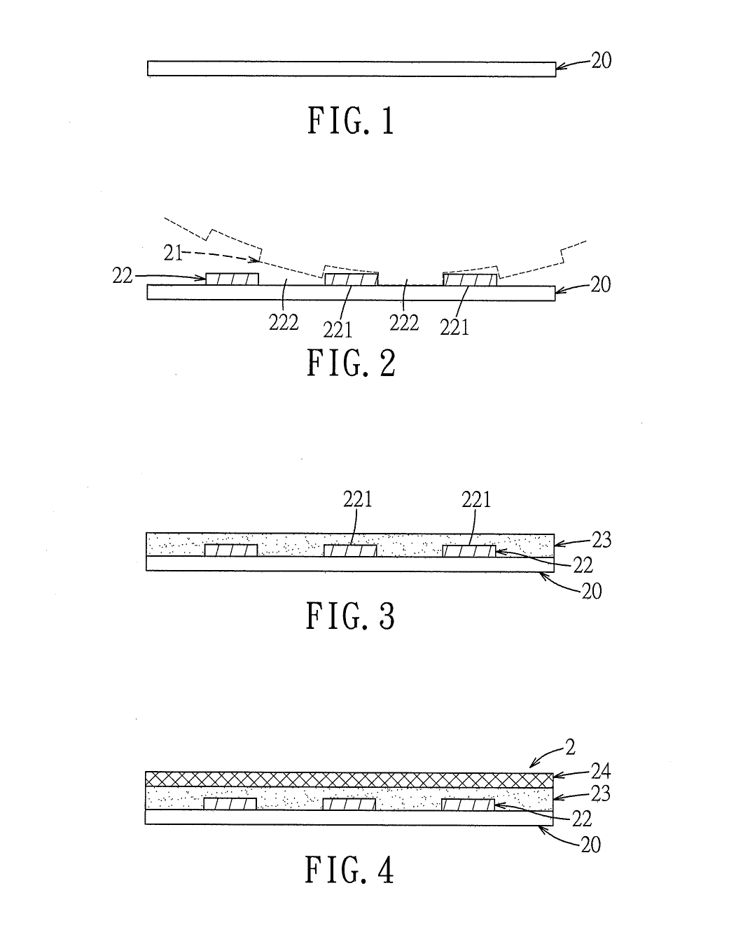

Referring to FIGS. 1 to 4, in an exemplary embodiment of this disclosure, a method for forming a hydraulic transfer film 2 includes the steps of:

(a) forming a pattern layer 22 on a water-soluble substrate 20 by gravure printing using a laser-engraved cylinder 21, the pattern layer 22 including at least two oil-soluble regions 221 that are separated from each other by a spacing 222, the water-soluble substrate 20 being exposed from the spacing 222;

(b) forming an oil-soluble base layer 23 on the water-soluble substrate 20 to cover the pattern layer 22 and to fill the spacing 222 between the at least two oil-soluble regions 221; and

(c) forming a curable activating layer 24 on the oil-soluble base layer 23 to obtain the hydraulic transfer film 2, the activating layer 24 including a curable activating agent that partially permeates into and is intermingled with the oil-soluble base layer 23 and the pattern layer 22.

The method may further include, after step (a) and before step (b), a step (d) of forming a decorative layer (not shown) on the pattern layer 22.

Exemplary techniques for forming the oil-soluble base layer 23, the curable activating layer 24 and the decorative layer include, but are not limited to, a printing technique, a spray coating technique, and a roller coating technique.

The water-soluble substrate 20 may be a polyvinyl alcohol (PVA) film. The laser-engraved cylinder 21 has a plurality of cells, each of which has a width ranging from 50 μm to 200 μm and a depth from a surface of the laser-engraved cylinder 21 ranging between 15 μm and 80 μm. Preferably, the depth of each of the cells ranges from 60 μm to 80 μm. In this embodiment, a gravure printing machine (commercially available as FCM-1300, from Yo Den Enterprises Co., Ltd.) including the laser-engraved cylinder 21 is used for forming the pattern layer 22 and the oil-soluble base layer 23. Each of the cells of the laser-engraved cylinder 21 has a width of 50 μm and a depth of 60 μm. The laser-engraved cylinder 21 has 175 lines per inch and is capable of full printout.

The oil-soluble regions 221 of the pattern layer 22 and the oil-soluble base layer 23 may each be made of an oil-soluble ink material. Commercial examples of the oil-soluble ink material include, but are not limited to, WAB-S01, SHC-UA01, SPI-UC01 and SPI-UF01 manufactured by Daigin Chemical Co., LTD. The oil-soluble ink material may further contain a plurality of micro powders including fuzz powders, wax, flat powders, or combinations thereof. In this embodiment, the oil-soluble regions 221 of the pattern layer 22 are made of WAB-S01, and may be formed with a carbon fiber texture. The oil-soluble base layer 23 is also made of WAB-S01.

The curable activating agent of the activating layer 24 can be cured by heat or radiation. The curable activating agent may be an ultraviolet curable agent. Commercial examples of the curable activating agent include, but are not limited to, UVAU-A01, UVAU-F01 and UVAU-C01 manufactured by Daigin Chemical Co., LTD. The curable activating agent may be used in an amount ranging from 10 g/m² to 60 g/m². In this embodiment, the curable activating agent is UVAU-A01 that is used in an amount of 15 g/m² and that is coated on the oil-soluble base layer 23 by wire bar coating to form the curable activating layer 24.

After the curable activating layer 24 is formed on the oil-soluble base layer 23, the hydraulic transfer film 2 is rested for 30 seconds for the curable activating agent to at least partially permeate into the oil-soluble base layer 23, through the decorative layer, and into the pattern layer 22. The curable activating agent of the activating layer 24 is intermingled with the oil-soluble base layer 23 and the pattern layer 22.

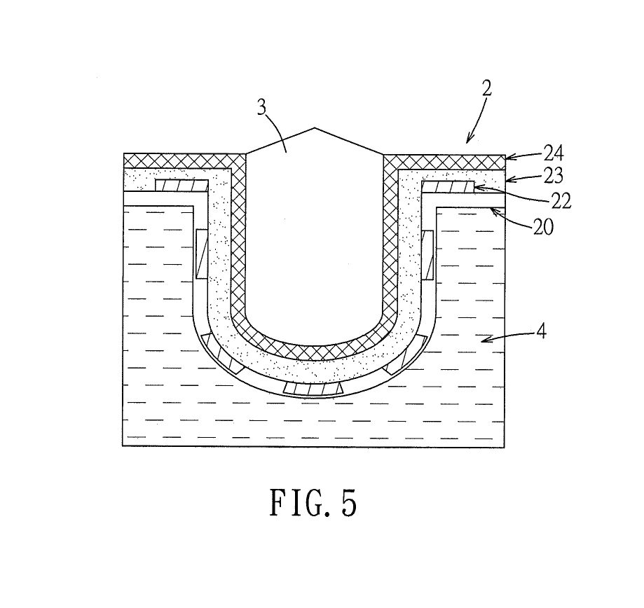

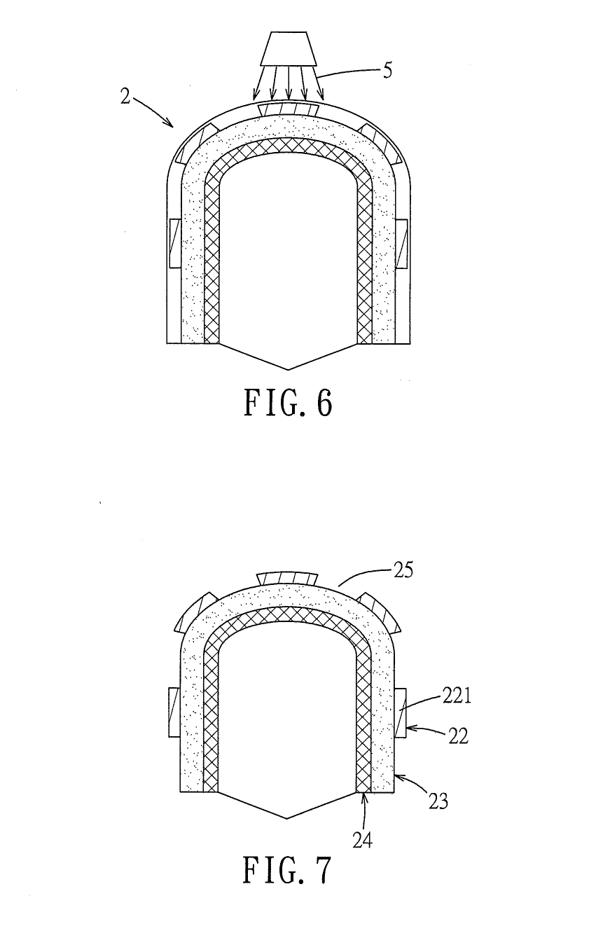

Referring to FIGS. 5 to 7, a hydraulic transfer method for forming a patterned article includes the following steps:

providing the aforesaid hydraulic transfer film 2;

contacting an article 3 with the curable activating layer 24 of the hydraulic transfer film 2, and pressing the water-soluble substrate 20 of the hydraulic transfer film 2 into water so that the hydraulic transfer film 2 covers the article 3, and the oil-soluble regions 221 of the pattern layer 22 project from the oil-soluble base layer 23 into the water-soluble substrate 20;

retrieving the article 3 and the hydraulic transfer film 2 from the water;

curing the curable activating agent in the curable activating layer 24; and

washing off the water-soluble substrate 20 to obtain the patterned article.

The article 3 maybe made of a plastic material (e.g., acrylonitrile butadiene styrene (ABS) or polycarbonates (PC), a metal-based material (e.g., a magnalium alloy) or a glass material. The article 3 has a surface that is to be coated with the hydraulic transfer film 2 and that may be planar or non-planar.

In this embodiment, the curable activating agent in the curable activating layer 24 is cured by ultraviolet light 5 that has an intersity of 1,000 mJ/cm².

Each of the oil-soluble regions 221 of the pattern layer 22 that project from the oil-soluble base layer 23 has a thickness greater than 5 μm and may be formed with a high-definition carbon fiber texture.

In other embodiments, each of the cells of the laser-engraved cylinder 21 may have a width of 200 μm and a depth of 80 μm. The water-soluble substrate 20 is removed by drying instead of washing. Each of the oil-soluble regions 221 of the pattern layer 22 that project from the oil-soluble base layer 23 also has a thickness greater than 5 μm and may also be formed with a high-definition carbon fiber texture.

### EXAMPLES

The following Exemplary Example and Comparative Example are provided to illustrate the embodiment of the disclosure, and should not be construed as limiting the scope of the disclosure.

Each of patterned articles of Exemplary Example and Comparative Example was manufactured by hydraulically transferring a hydraulic transfer film onto an acrylonitrile butadiene styrene (ABS) substrate. Type of the cylinder and the materials of the hydraulic transfer film for each of Exemplary Example and Comparative Example are listed in Table 1. The wear resistance of the patterned articles for Exemplary Example and Comparative Example were evaluated by RCA method that was conducted using an abrader (commercially available as 7-IBB, manufactured by Norman Tool, Inc.) with abrasive tape (manufactured by Norman Tool, Inc.) under 175 grams loading. The pattern layer 22 of the patterned article of Exemplary Example was able to withstand 1,800 abrasion cycles without exposing the oil-soluble base layer 23 under the pattern layer 22. In contrast, the pattern layer 22 of the patterned article of Comparative Example was worn out after 70 abrasion cycles, and the oil-soluble base layer 23 under the pattern layer 22 was exposed.

TABLE 1

| | | | | Cylinder Type |
|---|---|---|---|---|
| | Pattern Layer | Oil-soluble | Activating | (Cell Width/Depth in μm) |
| | 22 | Base Layer 23 | Layer 24 | (Numbers of lines per inch) |
| Exemplary | WAB-S01 | WAB-S01 | UVAU-A01 | laser-engraved |
| Example | | | | (50/60) |
| | | | | (175) |
| Comparative | HR-BA | HR-AA | UVAU-A01 | electronic-engraved |
| Example | (manufactured | (manufactured | | (10/30) |
| | by Hirotech | by Hirotech | | (175) |
| | Transfer | Transfer | | |
| | Technology | Technology | | |
| | Company Ltd.) | Company Ltd.) | | |

UVAU-A01 is capable of permeating into and being intermingled with HR-AA, but is incapable of being intermingled with HR-BA.

To sum up, each of the oil-soluble regions 221 of the pattern layer 22 formed by gravure printing using the laser-engraved cylinder 21 has a thickness greater than 5 μm. With the curable activating agent of the activating layer 24 partially permeating into the oil-soluble base layer 23 and the pattern layer 22, the hydraulic transfer film 2 exhibits desirable abrasion resistance.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for forming a hydraulic transfer film, comprising the steps of:
(a) forming a pattern layer on a water-soluble substrate by gravure printing using a laser-engraved cylinder, the pattern layer including at least two oil-soluble regions that are separated from each other by a spacing, the water-soluble substrate being exposed from the spacing;
(b) forming an oil-soluble base layer on the water-soluble substrate to cover the pattern layer and to fill the spacing between the at least two oil-soluble regions; and
(c) forming a curable activating layer on the oil-soluble base layer to obtain the hydraulic transfer film, the activating layer including a curable activating agent that partially permeates into and is intermingled with the oil-soluble base layer and the pattern layer.

2. The method as claimed in claim 1, wherein the laser-engraved cylinder has a plurality of cells, each of which has a width ranging from 50 μm to 200 μm.

3. The method as claimed in claim 1, wherein the laser-engraved cylinder has a plurality of cells, each of which has a depth ranging from 15 μm to 80 μm.

4. The method as claimed in claim 1, further comprising, after step (a) and before step (b), a step (d): forming a decorative layer on the pattern layer.
